(19) United States
(12) Patent Application Publication
(10) Pub. No.: US 2021/0121817 A1
(43) Pub. Date: Apr. 29, 2021

(54) AIR CLEANER

(71) Applicant: Toyota Jidosha Kabushiki Kaisha, Toyota-shi Aichi-ken (JP)

(72) Inventors: Tetsuya Ichikawa, Toyota-shi (JP); Koichi Masuda, Toyota-shi (JP)

(21) Appl. No.: 17/077,491

(22) Filed: Oct. 22, 2020

(30) Foreign Application Priority Data
Oct. 24, 2019 (JP) 2019-193386

(51) Int. Cl. B01D 46/42; B01D 46/00; B01D 53/04; B01D 53/88; B01J 35/04; B01J 23/04; B01J 21/18; B01J 23/34

(52) U.S. Cl. CPC B01D 46/4227; H01M 8/0687; B01D 46/0013; B01D 53/0415; B01D 53/885; B01J 35/04; B01J 23/04; B01J 21/18; B01J 23/34; B01D 2253/1124; B01D 2253/102; B01D 2253/25; B01D 2259/4566; B01D 2255/2073; B01D 2255/702; B01D 46/0036

(57) ABSTRACT

In an air cleaner, a cassette is removably installed in an air cleaner housing. The cassette holds therein a filter formed by stacking a chemical filter and an air cleaner element. At the time of replacement or inspection of the filter, the cassette is pulled out of the air cleaner housing, and then the filter is removed from the cassette. Further, after completion of the replacement or inspection, the filter is placed in the cassette, and the cassette is installed in the air cleaner housing.

### CROSS REFERENCE TO RELATED APPLICATION

This application claims priority to Japanese Patent Application No. 2019-193386 filed on Oct. 24, 2019, which is incorporated herein by reference in its entirety including the specification, claims, drawings, and abstract.

### TECHNICAL FIELD

The present disclosure relates to an air cleaner comprising a filter and configured to clean air.

### BACKGROUND

An air cleaner comprising a chemical filter for capturing contaminants and the like contained in air is known.

JP 2008-21500 A discloses an air cleaner for a fuel cell, in which a dust filter (corresponding to an air cleaner element) and a chemical filter are formed as one unit, and in which this unit is housed in a container, an air intake pipe and a downstream piping communicate with each other via an interior of the container.

JP 2006-179332 A discloses an air cleaner mounted on a fuel cell vehicle. In this air cleaner, a chemical filter and a dust filter (corresponding to an air cleaner element) are held in a single housing.

JP 2019-106306 A discloses that, in an air cleaner for a fuel cell vehicle, a chemical filter is sandwiched between a first prefilter and a second prefilter and then fitted into a housing member, and a filter element (corresponding to an air cleaner element) is further fitted into this housing member.

Typically, in an air cleaner, in order to increase the ability to remove contaminants and the like, an air cleaner element and a chemical filter are securely fastened to an air cleaner housing. However, at the time of replacing or inspecting the air cleaner element or the chemical filter, work for partially disassembling the air cleaner housing is necessary, and this results in low work efficiency. The above-noted three patent documents (i.e., JP 2008-21500 A, JP 2006-179332 A, and JP 2019-106306 A) include no discussion regarding work for filter replacement and inspection.

### SUMMARY

The present disclosure is directed to increasing the efficiency of work for replacement or inspection of an air cleaner element or a chemical filter in an air cleaner.

An air cleaner according to the present disclosure includes a cassette that holds therein an air cleaner element and a chemical filter, and an air cleaner housing in which the cassette is removably installed.

In one embodiment according to the present disclosure, the cassette is configured such that, among its respective faces located toward upstream and downstream of an air flow when the cassette is installed in the air cleaner housing, one of the faces is formed having a large-mesh structure including apertures into which a maintenance person can insert a finger, while the other face is formed as an opening part.

According to the present disclosure, a filter is held in a cassette that is removably installed in an air cleaner housing, so that filter replacement or inspection can be facilitated.

### BRIEF DESCRIPTION OF DRAWINGS

Embodiment(s) of the present disclosure will be described based on the following figures, wherein:

FIG. 1 is a schematic perspective view of a cassette in an air cleaner according to an embodiment;

FIG. 2 is a cross-sectional view of the cassette taken along plane A-A in FIG. 1;

FIG. 3 is an exploded view of the cassette and a filter; and

FIG. 4 is a disassembled view of a filter-containing cassette and an air cleaner housing.

### DESCRIPTION OF EMBODIMENTS

Embodiments will be described below by reference to the drawings. In the following description, specific aspects are illustrated to facilitate understanding. These aspects are shown simply as examples, and various other embodiments are possible.

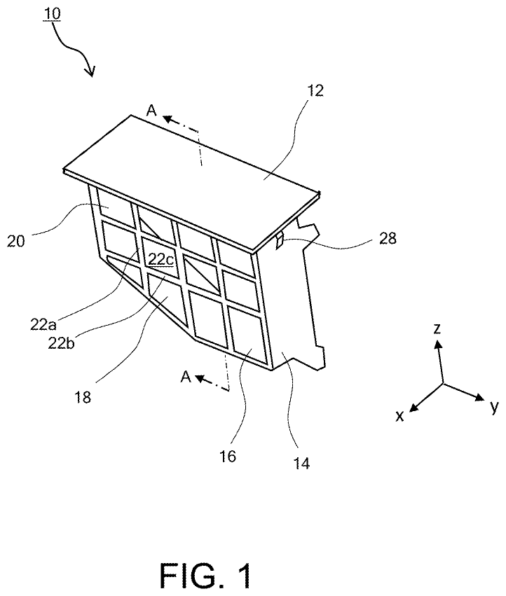

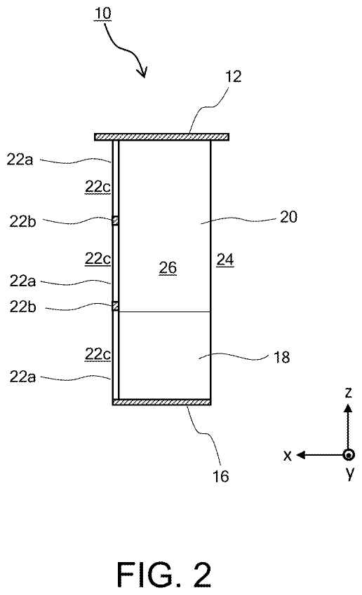

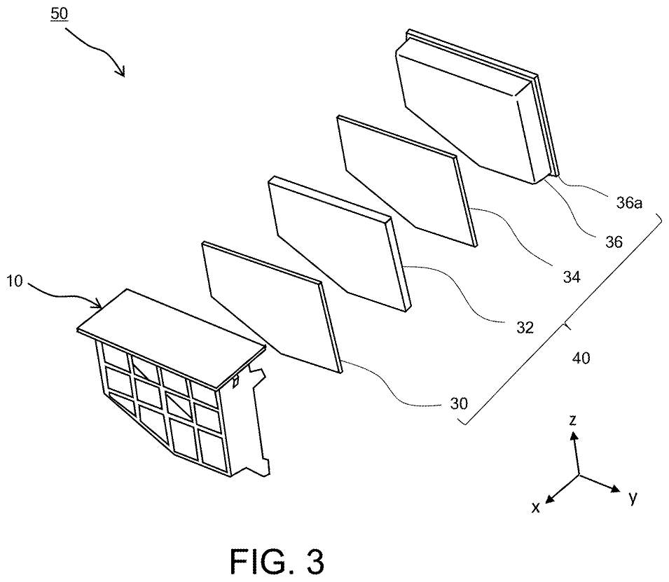

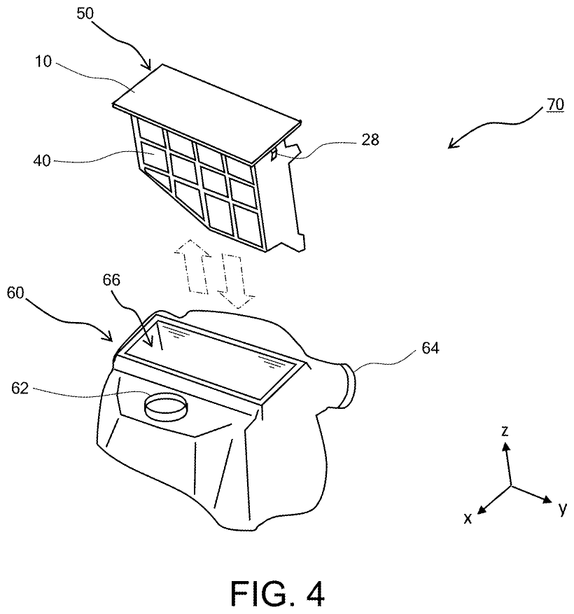

A cassette 10 constituting an air cleaner according to an embodiment is now described by reference to FIGS. 1 and 2. FIG. 1 is a perspective view of the cassette 10, and FIG. 2 is a cross-sectional view of the cassette 10 taken along plane A-A in FIG. 1. A common xyz coordinate system is used in FIGS. 1 and 2 (and also in FIGS. 3 and 4). The x-axis direction denotes the direction along which a filter is received into the cassette 10. The z-axis direction denotes the direction along which the cassette 10 is removed from the air cleaner.

The cassette 10 is a container which holds the filter. As shown in FIGS. 1 and 2, the cassette 10 is configured such that a space 26 in which the filter is held is enclosed by a top wall 12, a side wall 14, a bottom wall 16, a sloped wall 18, and a side wall 20. The top wall 12 is formed in a shape of a thin, rectangular plate. The top wall 12 extends beyond the space 26 in the positive and negative directions along the x-axis and the y-axis. This is so that, when the cassette 10 is installed in an air cleaner housing, the top wall 12 serves as a cover that closes off the air cleaner housing. Each of the side wall 14, the bottom wall 16, the sloped wall 18, and the side wall 20 is also formed in a thin, rectangular shape, while its extent in the x-axis direction is approximately identical to the extent of the space 26 in the x-axis direction.

An end face of the space 26 toward the positive side of the x-axis is defined by a plurality of vertical frame members 22a and a plurality of horizontal frame members 22b arranged in a lattice shape, which provide a large-mesh structure including a plurality of apertures 22c formed between the vertical frame members 22a and the horizontal frame members 22b. A mesh structure denotes a structure in which a large number of apertures 22c are distributed over a plane. When the filter is held within the space 26, the vertical frame members 22a and the horizontal frame members 22b serve as a stopper that prevents the filter from falling out from this end face. The apertures 22c not only provide an air flow path, but also may be used for pushing out the filter held within the space 26. For this purpose, a large-mesh structure is adopted so that a maintenance person's finger can be inserted through the apertures 22c. While the diameter of a maintenance person's finger varies among different individuals, the apertures 22c here are envisioned to have an approximate size that enables insertion of a thumb of 90% of the adult males living in the country or area in which the air cleaner is to be used. In general, an adult female's thumb tends to have a diameter smaller than that of an adult male's thumb, so that an adult female's thumb would have a still higher probability of being insertable into the apertures 22c.

The end of the space 26 toward the negative side of the x-axis is formed as an opening face 24 for allowing insertion and removal of the filter, with no material being provided in its central part. In the opening face 24, a flange may be provided partially or entirely along the peripheral edge of the opening, so as to support the filter and to prevent the filter from falling out.

On the outer surface of the side wall 14, a metallic leaf spring 28 is provided. The leaf spring 28 functions as a fixture for installation of the cassette 10 in the air cleaner housing.

The cassette 10 is formed by, for example, shaping resin using a mold and attaching thereto the metallic leaf spring 28. Alternatively, it is possible to configure such that leaf spring 28 is not provided on the cassette 10 but is instead attached to an air cleaner housing 60 described further below, and such that a corresponding engagement structure is provided on the cassette 10. Further, in place of the leaf spring 28, other fastening structures may be employed, such as a structure comprising resin walls that fit each other.

FIG. 3 is an exploded view showing how a filter 40 is received in the cassette 10. The filter 40 is formed by stacking, in order from the side toward the vertical frame members 22a and the horizontal frame members 22b of the cassette 10, a first prefilter 30, a chemical filter 32, a second prefilter 34, and an air cleaner element 36.

The first prefilter 30 and the second prefilter 34 are filters composed of a relatively thin, mesh member. The first prefilter 30 and the second prefilter 34 are arranged to sandwich the chemical filter 32 so as to protect the chemical filter 32. More specifically, the first prefilter 30 and the second prefilter 34 prevent entry of dust into the chemical filter 32, and also prevent scattering of alkali-impregnated activated carbon and the like applied to the chemical filter 32. However, the filter 40 may also be formed without providing one or both of the first prefilter 30 and the second prefilter 34.

The chemical filter 32 is a filter that removes chemical substances, such as contaminants contained in air, based on chemical effects. For example, the chemical filter 32 is formed by applying, to an aluminum thin-plate honeycomb which serves as a substrate, manganese dioxide particles and alkali-impregnated activated carbon which serve as catalysts. The aluminum thin-plate honeycomb is a member including a large number of small through-holes each having a diameter of approximately 1 to 2 mm. The manganese dioxide particles and the alkali-impregnated activated carbon are applied to the entire surface of the inner walls of the small through-holes, and serve to adsorb or chemically decompose chemical substances such as contaminants contained in the air that flows through the small through-holes.

The air cleaner element 36 is a filter that is also referred to as an air cleaner filter or an air filter. The air cleaner element 36 is composed of a fine-mesh member having air permeability, such as paper, non-woven fabric, or the like, and serves to physically remove sand, dust, and the like contained in outside air. In the illustrated example, a flange 36a is provided at an end of the air cleaner element 36 toward the negative direction along the x-axis, so as to prevent air leakage from side portions. Here, although the air cleaner element 36 is arranged downstream of the chemical filter 32 in the example shown in FIG. 3, the air cleaner element 36 may alternatively be arranged upstream of the chemical filter 32.

The filter 40 is received into the cassette 10 from the negative direction toward the positive direction along the x-axis. The filter 40 can be placed in the cassette 10 by sequentially stacking, in the cassette 10, the first prefilter 30, the chemical filter 32, the second prefilter 34, and the air cleaner element 36. Alternatively, some or all of the first prefilter 30, the chemical filter 32, the second prefilter 34, and the air cleaner element 36 may be stacked in advance and then placed into the cassette 10.

By setting the filter 40 in the cassette 10, a filter-containing cassette 50 is provided.

FIG. 4 is a disassembled view showing how the filter-containing cassette 50 is installed into the air cleaner housing 60. The air cleaner housing 60 is formed by, for example, combining a plurality of resin components shaped using a mold.

The air cleaner housing 60 comprises an air inlet 62 and an air outlet 64. The air inlet 62 is coupled to a flow path that introduces outside air. The air outlet 64 is, for example, coupled to a flow path that leads to a device such as a fuel cell.

The air cleaner housing 60 further comprises a cassette installation port 66. The filter-containing cassette 50, which is the cassette 10 having the filter 40 set therein, is installed in this cassette installation port 66. During the process of installing the filter-containing cassette 50 in the cassette installation port 66, the leaf spring 28 of the cassette 10 undergoes elastic deformation, as a result of which it becomes possible to push the filter-containing cassette 50 into the cassette installation port 66. After the installation is completed, the leaf spring 28 serves to prevent the filter-containing cassette 50 from falling out of the cassette installation port 66, and to also prevent air leakage by enhancing sealing between the cassette 10 and the air cleaner housing 60.

When the filter-containing cassette 50 is installed in the air cleaner housing 60, the relatively large top wall 12 of the cassette 10 serves as a cover that closes off the cassette installation port 66. As a result, air leakage from the cassette installation port 66 is prevented. An elastic resin member or the like for preventing air leak can also be provided as necessary at portions where the cassette installation port 66 and the top wall 12 contact each other.

At the time of removing the filter-containing cassette 50, the filter-containing cassette 50 is pulled up with a considerably large force. Due to this force, the leaf spring 28 undergoes elastic deformation, so that the filter-containing cassette 50 becomes detachable.

The air cleaner 70 is installed in, for example, a front part of a fuel cell vehicle. During operation of the fuel cell, outside air is introduced via the air inlet 62 of the air cleaner housing 60. The air taken into the air inlet 62 passes through the filter 40 inside the cassette 10. More specifically, the air sequentially passes through the first prefilter 30, the chemical filter 32, the second prefilter 34, and the air cleaner element 36. During this process, the chemical filter 32 removes fine chemical substances. Further, the air cleaner element 36 removes sand, dust, and the like. Dust to be removed also includes microparticulate matters such as so-called PM2.5. The air cleaned as such is discharged from the air outlet 64 and delivered to the fuel cell.

When the fuel cell vehicle is operated over a long period of time, cleaning performance of the filter 40 degrades gradually. Specifically, the chemical filter 32 deteriorates due to chemical reaction, and its cleaning performance is also degraded by dirt. Further, in the air cleaner element 36, sand and dust deposit and cause clogging, which results in degradation of cleaning performance. Accordingly, work for replacing the filter 40 becomes necessary.

In the fuel cell vehicle, at a time of periodic inspection or the like, the filter-containing cassette 50 is removed from the air cleaner housing 60. Further, the filter 40 is removed from the cassette 10 by pushing out the filter 40 with a finger or the like via an apertures 22c of the cassette 10. The state of the removed filter 40 is checked by sight or other methods, so as to determine necessity for replacement. Further, necessity for replacing the filter 40 may also be determined based on factors such as the distance traveled or the state of a test paper for detecting degradation. In accordance with the check result, one or both of the chemical filter 32 and the air cleaner element 36 are replaced as necessary. Furthermore, the first prefilter 30 and the second prefilter 34 may also be replaced as necessary.

Regardless of whether or not replacement of the filter 40 is carried out, a filter 40 is placed back into the cassette 10. The filter-containing cassette 50 is then installed in the air cleaner housing 60, to form an air cleaner 70.

In the air cleaner 70, since the filter-containing cassette 50 has a cassette type structure, the filter-containing cassette 50 can be installed in and removed from the air cleaner housing 60 any number of times. Further, since the filter-containing cassette 50 can be installed by simply being pushed in and can be removed by simply being pulled up, installation and removal can be carried out easily in a short period of time. As such, work for replacement or inspection of the filter 40 becomes more efficient.

According to the above description, the air cleaner 70 is configured such that the side of the cassette 10 toward the vertical frame members 22a and the horizontal frame members 22b is the upstream side from which air flows. For this reason, due to air pressure, the filter 40 is pushed toward the opening face 24 of the cassette 10. However, in the embodiment, it is assumed that the filter 40 is received in the cassette 10 by being forced into the cassette 10 with considerable pressure, and that the filter 40 would not be pushed out from the opening face 24. If there are possibilities that the filter 40 can be moved by air pressure, the orientation of the cassette 10 may be designed so that the vertical frame members 22a and the horizontal frame members 22b are located toward the downstream of the air flow.

When performing a replacement regarding the air cleaner 70, a new filter-containing cassette 50 may be installed in place of a removed filter-containing cassette 50. In other words, it is possible to employ a cartridge system in which the cassette 10 and the filter 40 are entirely replaced.

In the above description, it is assumed that the air cleaner 70 is used for a fuel cell vehicle. However, the air cleaner 70 according to the embodiment can also be applied to other mobile units and facilities that employ fuel cells, and can further be applied to mobile units (including vehicles) and facilities that do not employ fuel cells.

1. An air cleaner comprising:
a cassette that holds therein an air cleaner element and a chemical filter; and
an air cleaner housing in which the cassette is removably installed.

2. The air cleaner according to claim 1, wherein
the cassette is configured such that, among its respective faces located toward upstream and downstream of an air flow when the cassette is installed in the air cleaner housing, one of the faces is formed having a large-mesh structure including apertures into which a maintenance person can insert a finger, while the other face is formed as an opening part.
